(19) United States
(12) Patent Application Publication
(10) Pub. No.: US 2017/0371875 A1
(43) Pub. Date: Dec. 28, 2017

(54) INFORMATION ITEM RETRIEVAL

(71) Applicant: QOOEE HOLDINGS PTY LTD, Officer, Victoria 3809 (AU)

(72) Inventor: Vedran ASKRABA, Officer, Victoria 3809 (AU)

(21) Appl. No.: 15/539,686

(22) PCT Filed: Dec. 23, 2015
(86) PCT No.: PCT/AU2015/050842

§ 371 Date: Jun. 25, 2017

(30) Foreign Application Priority Data
Jan. 7, 2015 (AU) 2015900030
Oct. 26, 2015 (AU) 2015904372

(51) Int. Cl. G06F 17/30; G06F 19/28

(52) U.S. Cl. CPC G06F 17/30044; G06F 19/28; G06F 17/30106; G06F 17/30321

(57) ABSTRACT

The invention provides a method and system for enabling a user (100) to identify one or more information items which the user (100) or another party has previously accessed, the method comprising the steps of: recording in a computer readable storage medium concurrent attributes (101) concerning one or more events or computer system states occurring concurrently with the previous access of the information items by the user (100) or other party; receiving a search request specification (102) from the user (100) seeking to find one of the previously accessed information items, the search request specification comprising one or more specified concurrent attributes (30,40,50) including at least one unrelated concurrent attribute (50) which bears no relation, other than concurrence, to the previously accessed information item being sought or to the previous access thereof; accessing the recorded concurrent attributes and identifying to the user one or more of the previously accessed information items which satisfy the search request specification.

### FIELD

The present invention relates to retrieval of information items, including but not limited to media items such as word processing documents, publications, academic articles, books, self-generated media items, business documents, recreational files, music or other sound files, movies or other video files, HTML files including websites, and web-based news items. Information items of interest may also include data items such as telephone numbers, addresses and the like. In particular, the present invention discloses an improved system and method for retrieving information items which are imperfectly and associatively recollected by the searcher.

### BACKGROUND

With the explosion of available data and the amount of browsing and access to information items experienced by people in all walks of life, there is an increasing need for improvements in assisting people to find documents they have previously viewed or accessed amongst the myriad possibilities of where they may have viewed or accessed them. A particular document is often no longer stored on the person's individual computer or often even on an individual person's cloud data storage, it may have been viewed or edited on the Internet without taking a copy. While keyword searches are increasingly powerful and effortlessly search indexed search databases on the Internet as well as automatically updated indexed databases on the person's computer equipment, it is commonly the case that a person remembers not particular keywords, but other aspects about the interaction.

There has been some recognition in recent attempts to improve searches that people often remember aspects other than keywords about an access of an information item, such as other meta data including time of access, how often accessed, what was done to the information item such as printing, where the items were stored, or whether the item was edited. For example, U.S. Pat. No. 8,122,028 and US patent application publication 20090006475 contemplates indexing meta data such as the amount of time spent on a document, the frequency with which the document was viewed, and other user metrics related to the document and its treatment.

The inventor has recognised that the associative character of human memory can be better exploited in search and retrieval by expanding indexing parameters further, including parameters which have no direct relation to the documents themselves. There are many examples of memories which are easily recalled because of their indirect association with other memorable events which bear no relation other than concurrence—for example, most people who remember the assassination of JFK or the moon landing or the destruction of the twin towers can vividly picture years later where they were and what they were doing when the events occurred. Similarly many people have episodic memories in which temporally related events in the episode are able to be recalled whenever a single event in the episode is recalled. For example, viewing a favourite vase which was given as a present may trigger the memories of the day the vase was given unrelated to the actual presentation of the vase or the giver. Such memories are useless in existing search engines which always use a search specification as a template for properties or content being searched for, and only return information items matching or nearly matching the properties or content of the template.

### SUMMARY OF THE INVENTION

According to a first broad aspect of the invention there is provided a method of enabling a user to identify one or more information items which the user or another party has previously accessed, the method comprising the steps of:

recording in a computer readable storage medium concurrent attributes concerning one or more events or computer system states occurring concurrently with the previous access of the information items by the user or other party;

receiving a search request specification from the user seeking to find one of the previously accessed information items, the search request specification comprising one or more specified concurrent attributes including at least one unrelated concurrent attribute which bears no relation, other than concurrence, to the previously accessed information item being sought or to the previous access thereof;

accessing the recorded concurrent attributes and identifying to the user one or more of the previously accessed information items which satisfy the search request specification.

In one embodiment, the recorded concurrent attributes are recorded in an index of each concurrent attribute identifying which of the information items previously accessed by the user were previously accessed concurrently with the concurrent attribute, and the step of accessing the recorded concurrent attributes includes accessing the index entry of the specified concurrent attribute.

In one embodiment, the events or computer system states include whether a particular program or file was being accessed concurrently.

In one embodiment, the events or computer system states include whether a particular website was being accessed concurrently.

In one embodiment, the events or computer system states include news events.

In one embodiment, the events or computer system states include whether a particular music item was being played by the user.

In one embodiment, the specified concurrent attributes further include other attributes which are related to the previously accessed information item being sought and which are attributes of the previously accessed information being sought or attributes of the previous access thereof.

In one embodiment, the other attributes include attributes concerning content of the information items.

In one embodiment, the information items include a print publication item and the attributes concerning content of the information item include one or more of: words, phrases, colours, number of pages, number of charts, layout, title, author, year of publication, and publisher.

In one embodiment, the other attributes include attributes concerning actions the user performed with the information item.

In one embodiment, the attributes concerning actions the user performed with the information item include one or more of: a date of access, a time of access in the day, a time spent reading, a number of times viewed, whether the item was printed, whether the item was annotated, whether the user copied text from the item to a clipboard, and whether the item was viewed online.

According to a second broad aspect of the invention there is provided a system for enabling a user to identify one or more information items which the user or other party has previously accessed, the system comprising:

a concurrent attribute recorder adapted to record in a computer readable storage medium concurrent attributes concerning one or more events or computer system states occurring concurrently with the previous access of the information items by the user or other party;

a request receiver adapted to receive a search request specification from the user seeking to find one of the previously accessed information items, the search request specification comprising one or more specified concurrent attributes including at least one unrelated concurrent attribute which bears no relation, other than concurrence, to the previously accessed information item being sought or to the previous access thereof;

a search results processor adapted to access the recorded concurrent attributes and identify to the user those of the previously accessed information items which satisfy the search request specification.

In one embodiment, the concurrent attribute recorder records concurrent attributes in an index of each concurrent attribute identifying which of the information items previously accessed by the user were previously accessed concurrently with the concurrent attribute, and the search results processor accesses the index entry of the specified concurrent attribute.

### BRIEF DESCRIPTION OF DRAWINGS

FIG. 1 is a screenshot of a user interface with a search request receiver according to an embodiment of the system the invention;

FIG. 2 is a block diagram of system components of a concurrent attribute recorder in accordance with the embodiment of FIG. 1;

FIG. 3 is a block diagram of method steps in accordance with an embodiment of the invention.

### DETAILED DESCRIPTION OF EMBODIMENTS

An embodiment of the current invention will now be described.

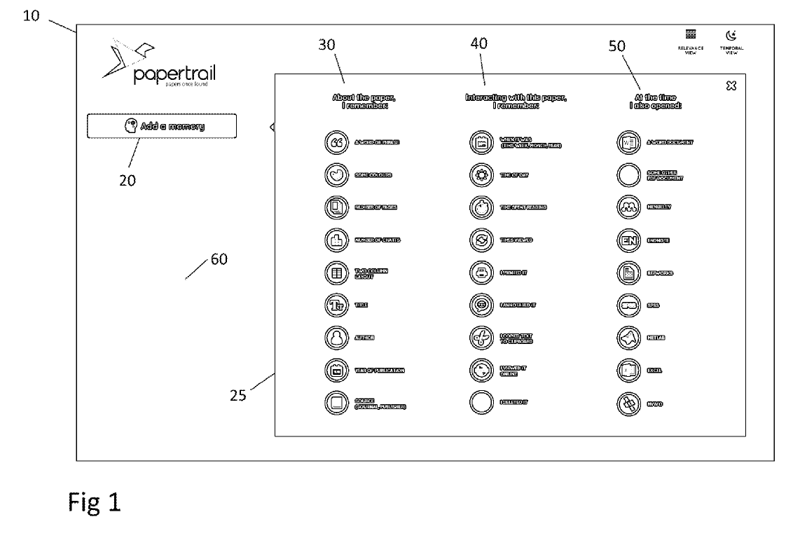

Referring first to FIG. 1, a screenshot 10 is shown of a user interface to a request receiver program according to an embodiment of the invention, adapted to receive from the user a search request specification. On the left of the screen is a button 20 entitled “add a memory” which when selected by the user using a pointing device such as pen, mouse or touch opens a balloon 25 detailing options for specifying a search request.

The options are classified into columns representing 3 categories 30, 40, 50. Leftmost column 30 headed “about the paper, I remember:” lists attributes of the information item from which the user can pick the relevant criteria. The listed criteria “a word or phrase” when selected opens a dialogue to specify a keyword or phrase which the user may remember or may consider relevant to the topic of the document. The listed criterion “some colours” opens a dialogue to specify a set of colours in the layout of the information item which the user may remember. Similarly, other criteria are for specifying number of pages, number of charts, whether the document was in 2 column layout, the title, the author, the year of publication, and the source (journal or publisher). The user may select and specify one or more remembered or relevant attributes of the information item from column 30 which then are summarised in an area 60 to the left of the screen.

The middle column 40 entitled “interacting with this paper, I remember:” lists attributes of the previous access of the information item by the user. Selecting the first criterion “when it was” opens a dialogue for the user to provide a date or range of dates over which the user recalls or suspects the access of the file occurred. Selecting the listed criterion “time of day” opens a dialogue for the user to specify a time of day (morning, midday, afternoon, evening) which the user might remember or suspect that the information item was accessed. As with column 30, the user may select and specify one or more remembered or relevant attributes of the access of the information item from column 40 which then are added as additional criteria of the search request specification in area 60 to the left of the screen.

Illustrating a key feature of the current invention, the right most column 50 entitled “at the time I also opened:” lists attributes concerning one or more events or computer system states occurring concurrently with the previous access of the information items, in this embodiment all relating to the computer system state of one or more programs being concurrently opened on the same computer as the information item was accessed, optionally accessing a particular file. These concurrent events or computer system states are not attributes of the information item being searched or attributes of the previous access of the information item (as in columns 30 and 40) but are associated events or computer system states which the user might remember or suspect. Selecting the first criterion entitled “a Word document” may open a dialogue where the user can specify if desired a particular Word document which they remember or suspect was being viewed or edited at the same time. If no particular Word document is specified, the search criteria will include any Word document being opened concurrently. As with column 30 and 40, the user may select and specify one or more remembered or relevant concurrent attributes from column 50 which then are added as additional criteria of the search request specification in area 60 to the left of the screen.

In other embodiments of the invention, the unrelated concurrent attributes can include whether a particular website was being accessed concurrently, or even as in the example of the introduction where the user associated a news event with the access of the information item, a concurrent news topic, which might be specified by the use of keywords. Further, the unrelated concurrent attributes can include whether a particular music item was being played by the user. Further still, the unrelated concurrent attributes can relate to concurrent events which happened elsewhere, such as news events or actions of other people, but could also be actions of the user occurring on a different computer or device from a computer or device being accessed by the user, either at the time of the event or at the time of the search. For example, a user may search on a first device and the specified unrelated concurrent attribute is a phone call on a 2nd device such as a mobile phone, whereas the sought for information item may have been accessed on a 3rd device such as a computer or tablet.

Further still, the unrelated concurrent attribute may concern a social event such as a tweet, or being mentioned in a tweet by someone else. Further still, the unrelated concurrent attribute can relate to a minimally specified type of event. For example, the user may recall having deleted a file at the concurrent time, but may not remember which file, the “minimally specified type of event” being “deletion of some file”.

Once the user has completed the search request specification which is summarised in area 60 (which may include Boolean operators combining the factors using other than AND), a search results processor parses the search request specification and accesses one or more databases containing relevant records. In respect of parts of the search request specification relating to attributes of the sought information item itself (column 30) such as keywords, a conventional or existing indexed system database may be consulted and an interim list of information items satisfying all of the column 30 criteria may be produced internally within the search results processor. In respect of other attributes in column 40 and particularly column 50 which are not normally indexed, one or more special purpose databases may be consulted to complete the processing of the search request. The special purpose databases have been constructed by programs running in the background, system programs or application add-ins as described below depending on the nature of the attribute, not necessarily on the same device. For the concurrent attributes in column 50, the special purpose database is indexed in this embodiment by a timestamp and each database entry comprises a timestamp and identifiers of the monitored application such as Microsoft Word, Excel etc which was running at the time and optionally also identifiers of which files the monitored application was actively editing. Some of the special purpose database entries will be entries that were generated during previous access of the sought information item using one of the monitored applications. The search results processor is then able to match database entries for which the timestamps may be regarded as “concurrent”, meaning occurring within a threshold time difference, to finally identify to the user one or more of the previously accessed information items which satisfies all of the search request specification. The threshold time difference is broadly any amount of time relevant to a user system or the particular unrelated concurrent attribute, and in the examples given here is typically about 30 minutes. The threshold time difference may in some embodiments be selectable by the user as an input parameter during the search.

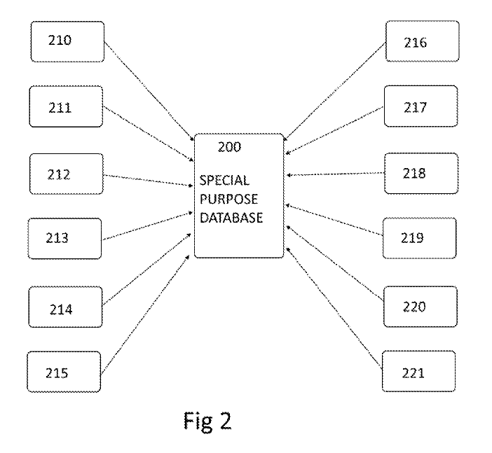

Referring now to FIG. 2, a schematic of the system components of a concurrent attribute recorder in accordance with the current embodiment is provided. A number of processes 210-221 operate independently to monitor user and computer activity, and periodically (or immediately as specific events occur) cause the creation of a database entry in special purpose database 200. In the current prototype the processes communicate with a central or separate process which in turn creates a database entry, but in other embodiments the individual processes may directly create database entries. In the case of editing and viewing programs such as Microsoft Word, Microsoft Excel, Adobe Acrobat and similar, application add-ins are installed at the time of system installation. Each application add-in is programmed to gather the required information at each recording interval, such as which information items were opened in the application, and cause the creation of a database entry identifying the information items, the application concerned and the timestamp. Typically, special purpose database 200 is an indexed database and the database entries are created as for example using an SQL or NoSQL statement.

In the case of certain attributes, particularly some of those listed in column 40, the information may only be able to be recorded by resident programs monitoring system activity, such as for example the “I deleted it” option in column 40. The completeness and breadth of the system of the invention depends on a number of processes working in tandem and in different embodiments these can be implemented in a number of ways, as will be appreciated by a person skilled in the art.

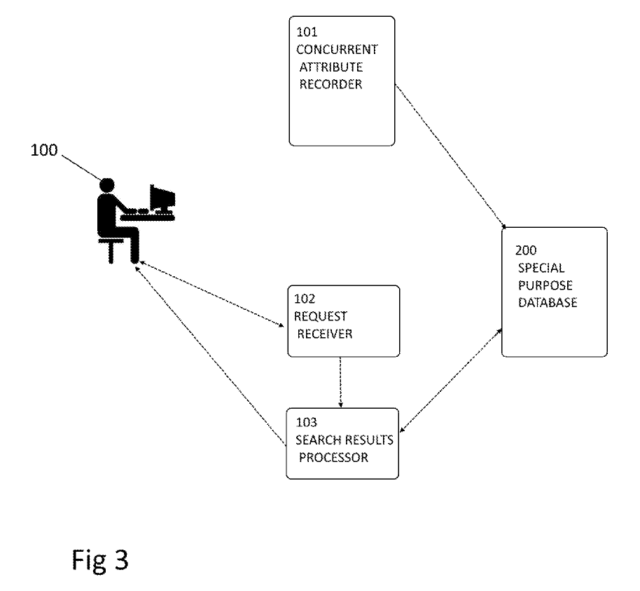

Referring now to FIG. 3, an overview of the modules of the system is provided. Concurrent attribute recorder 101 as described above composed of a multiplicity of processes and application add-ins operates in the background and is able to write to special purpose database 200. User 100 is in interface communication with search request receiver 102 such as described in FIG. 1, which passes control to search results processor 103 which is able to read from special purpose database 200 and possibly other databases to process the search request and finally to communicate to user 100 those of the previously accessed information items which satisfy the search request specification.

Embodiments of the invention may include a facility whereby a user's calendar is consulted as a de facto recording of events with timestamps. For example, the unrelated concurrent attribute may be dinner at a particular restaurant that the user remembers as being concurrent. The system would then search the user's calendar for entry relating to the restaurant name and search for information items accessed around the scheduled date and time in the calendar within the threshold of concurrency.

The invention provides a search and retrieval method and system which is particularly attuned to the associative nature of human memory, by allowing search specification to include attributes not of the information files or their access, but of concurrent events or computer states.

Persons skilled in the art will also appreciate that many variations may be made to the invention without departing from the scope of the invention, which is determined from the broadest scope and claims. There are many established ways of automatically indexing files and providing a record of computer activity and the invention is not restricted to any particular method of achieving the broad aim.

For example, while the example above involves on the fly recording and indexing of the concurrent events or computer system states with the information items, as explained above the broadest aspect of the invention extends to methods and systems where the concurrent events or computer system states can be identified at a later date by matching recorded times of the events or computer system states with recorded times of access of the information item. Also, concurrency may be recorded in some embodiments without using a timestamp, instead including for example a measurement of a relative time from a previous event, or directly classifying attributes as concurrent at the time of the events without recording an absolute timestamp.

Further, as will be appreciated by a person skilled in the art, the processing and data storage elements of the invention including the concurrent attribute recorder, the request receiver and the search results processor may be distributed in physical location such as on one or more servers or more traditionally may be located directly on a computer in device of the user.

Further also, events may be detected by examining network traffic or packets, either at a user's device or even a network gateway level, listening to an entire network for traffic relating to one or many devices.

Further also, while most of the instances of the use of the invention will involve searching for media files, the user may also be searching for discrete information items such as a phone number or address that may be within a media item such as an address file or an email record, and accordingly the broadest aspect of the invention relates to retrieval of information items in a broad sense.

The term “attribute” in the claims, unless qualified or except where the context requires otherwise, extends to any feature or property of an event or computer system state including the examples given above. The term “events or computer system states” extends to concurrent access of other information items such as other media files, and “attribute” in relation to concurrent access of such other information items can include content of such other information items.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention. Further, any method steps recited in the claims are not necessarily intended to be performed temporally in the sequence written, or to be performed without pause once started, unless the context requires it.

It is to be understood that, if any prior art publication is referred to herein, such reference does not constitute an admission that the publication forms a part of the common general knowledge in the art, in Australia or any other country.

1. A method of enabling a user to identify one or more information items which the user or another party has previously accessed, the method comprising the steps of:
recording in a computer readable storage medium concurrent attributes concerning one or more events or computer system states occurring concurrently with the previous access of the information items by the user or other party;
receiving a search request specification from the user seeking to find one of the previously accessed information items, the search request specification comprising one or more specified concurrent attributes including at least one unrelated concurrent attribute which bears no relation, other than concurrence, to the previously accessed information item being sought or to the previous access thereof;
accessing the recorded concurrent attributes and identifying to the user one or more of the previously accessed information items which satisfy the search request specification.

2. The method of claim 1, wherein the recorded concurrent attributes are recorded in an index of each concurrent attribute identifying which of the information items previously accessed by the user were previously accessed concurrently with the concurrent attribute, and the step of accessing the recorded concurrent attributes includes accessing the index entry of the specified concurrent attribute.

3. The method of claim 1, wherein the events or computer system states include whether a particular program or file was being accessed concurrently.

4. The method of claim 1, wherein the events or computer system states include whether a particular website was being accessed concurrently.

5. The method of claim 1, wherein the events or computer system states include news events.

6. The method of claim 1, wherein the events or computer system states include whether a particular music item was being played by the user.

7. The method of claim 1, the specified concurrent attributes further include other attributes which are related to the previously accessed information item being sought and which are attributes of the previously accessed information items being sought or attributes of the previous access thereof.

8. The method of claim 7, wherein the other attributes include attributes concerning content of the information items.

9. The method of claim 8, wherein the information items include a print publication item and the attributes concerning content of the information item include one or more of: words, phrases, colours, number of pages, number of charts, layout, title, author, year of publication, and publisher.

10. The method of claim 7, wherein the other attributes include attributes concerning actions the user performed with the information item.

11. The method of claim 10, wherein the attributes concerning actions the user performed with the information item include one or more of: a date of access, a time of access in the day, a time spent reading, a number of times viewed, whether the item was printed, whether the item was annotated, whether the user copied text from the item to a clipboard, and whether the item was viewed online.

12. A system for enabling a user to identify one or more information items which the user or another party has previously accessed, the system comprising:
a concurrent attribute recorder adapted to record in a computer readable storage medium concurrent attributes concerning one or more events or computer system states occurring concurrently with the previous access of the information items by the user or other party;
a request receiver adapted to receive a search request specification from the user seeking to find one of the previously accessed information items, the search request specification comprising one or more specified concurrent attributes including at least one unrelated concurrent attribute which bears no relation, other than concurrence, to the previously accessed information item being sought or to the previous access thereof;
a search results processor adapted to access the recorded concurrent attributes and identify to the user those of the previously accessed information items which satisfy the search request specification.

13. The system of claim 12, wherein the concurrent attribute recorder records concurrent attributes in an index of each concurrent attribute identifying which of the information items previously accessed by the user were previously accessed concurrently with the concurrent attribute, and the search results processor accesses the index entry of the specified concurrent attribute.
